(19) United States
(12) Patent Application Publication
(10) Pub. No.: US 2012/0272629 A1
(43) Pub. Date: Nov. 1, 2012

(54) ANTI-POLLUTION, ANTI-BACTERIAL, WATER RESISTANT BABY COVER

(76) Inventors: Adoram Leshem, Tel Aviv (IL); Yaron Genigar, Tel Aviv (IL); Ori Ellman, Tel Aviv (IL)

(21) Appl. No.: 13/520,626

(22) PCT Filed: Dec. 30, 2010
(86) PCT No.: PCT/IL10/01093

§ 371 Date: Jul. 5, 2012

(30) Foreign Application Priority Data
Jan. 5, 2010 (IL) 203138

(51) Int. Cl. B01D 39/14

(52) U.S. Cl. 55/385.2

(57) ABSTRACT

A cover of a means for holding children and/or babies, the holding means having at least one opening, wherein the cover includes: (a) means for releasable fastening to the holding means, wherein attachment of the cover to the holding means enables the cover to match its form to openings of the holding means, (b) a layer configured to at least partially filter air introduced via the openings into the holding means, the layer including at least one layer including non-woven material, and (c) at least one window, whereby the child in the holding means is capable of viewing outside the holding means. The windows include a layer impermeable to at least one of the group including dust, air pollutants, viruses, (Rubber) bacteria, UV radiation, liquids and insects.

### FIELD OF THE INVENTION

The present invention generally relates to filtration means for protecting infants against air pollution contaminants and against viruses' and bacteria's morbidities. More particularly, the present invention relates to a cover configured to at least partially enclose, and to filter the air introduced into, babies strollers, carry-cots, and their means for babies transportation and stay.

### BACKGROUND OF THE INVENTION

The increasing environment pollution and the increasing viruses and bacterias morbidities (both in volume and in viruses/bacterias durability) and other morbidities requires new solutions for raising babies in a safer and healthier environment.

It is known that babies in their early stages of life are more sensitive and vulnerable to environmental afflictions like dust pollutants, air pollution, bacterias and viruses. Babies immune system is not fully developed and therefore they are more vulnerable in their early stages of life. The present invention aims to provide a cover for protecting babies in areas wherein possible afflicted people are present (e.g. visits to Doctors, hospitals), and wherein dust pollutants and other air pollutants are common e.g. industrial metropolis, noisy streets, cafe's/bars with smoking areas etc.

### SUMMARY OF THE INVENTION

One aspect of the invention provides a cover of a means for holding children and/or babies, the holding means having at least one opening, wherein the cover comprises:
a. means for releasable fastening to the holding means, wherein attachment of the cover to the holding means enables the cover to match its form to openings of the holding means;
b. a layer configured to at least partially filter air introduced via the openings into the holding means, the layer comprising at least one layer comprising non-woven material;
c. at least one window, whereby the child in the holding means is capable of viewing outside the holding means, the windows comprising a layer impermeable to at least one of the group comprising: dust, air pollutants, viruses, bacteria, UV radiation, liquids and insects.

The cover may further comprise at least one layer comprising film fabric material.

In some embodiments, the cover comprises at least two layers, wherein the inner layer comprises film fabric material and the outer layer, facing openings of the holding means, comprises non-woven material.

Preferably, areas of the cover facing openings of the holding means are at least partially permeable to oxygen and carbon dioxide and at least partially impermeable to at least one of the group comprising: dust, air pollutants, smog, viruses, bacteria, UV radiation, liquids and insects.

In some embodiments, the cover is configured to at least partially block or reduce exposure of the child and/or baby from wind and/or light and/or noise and/or shock.

The cover, may further comprise attachment means comprising at least one of the group comprising drawstring, ribbon, Velcro, elastic band, cincture, hook, latch, lock, snare, snap, closure, clasp, snap fastener, pop fastener or press fastener, or clip.

The releasable fastening means may be configured to match the form of the cover to openings of the holding means when the fastening means is tightened around the openings.

In some embodiments, the tightening allows partial uncovering of the opening by removing or folding a portion of the cover.

Some embodiments may further comprise a light-impenetrable foldable layer for covering the window, for example to help shade the child/baby from strong light.

In some embodiments, particularly for use in cold regions, the cover may be configured to help retain heat within the holding means.

According to another aspect of the invention, the invention provides means for holding children and/or babies, having at least one opening, configured to at least partially filter air introduced via the openings into the holding means and allow the baby and/or child viewing outside the holding means, by attachment of at least one cover comprising:
a. means for releasable fastening to the holding means, wherein attachment of the cover to the holding means enables the cover to match its form to openings of the holding means;
b. a layer configured to at least partially filter air introduced via the openings into the holding means, the layer comprising at least one layer comprising non-woven material;
c. at least one window, whereby the child in the holding means is capable of viewing outside the holding means, the windows comprising a layer impermeable to at least one of the group comprising: dust, air pollutants, viruses, bacteria, UV radiation, liquids and insects.

Preferably, the covers enclose openings of the holding means.

Preferably, the holding means is configured with means for releasable fastening to attachment means on the filtering covers, wherein attachment of the covers to the holding means enables the covers to match their form to openings of the holding means.

The holding means may be selected for example from the group comprising: baby stroller, baby pram, baby carrier, baby carry-cots, baby incubator, baby bed, child bicycle seat or carriage, basinet, child motorcycle seat or carriage and rickshaw compartment.

In some embodiments, the holding means may further comprise a scaffold upon which at least one cover is laid, such as to create a comfortable gap between the child or baby and at least one cover.

### DETAILED DESCRIPTION OF PREFERRED EMBODIMENTS

The present invention provides a cover for filtering the air introduced into baby strollers, baby carry-cots, and other means designed for babies stay and transportation (generally referred to herein as infants' facilities). The cover of the present invention is designed to at least partially enclose infants' facilities such that the air passage thereinto is passed through said cover and filtered by filtration means comprised therein. Of course, the cover of the invention may be configured to enclose any other means wherein babies are held, based on its size e.g. baby incubator, baby bed. The cover of the present invention protects the baby in the infant's facility from exposure to dust pollutants, air pollutants, bacteria and viruses. In addition, said cover further protects the baby from water (or any other liquid), insects and sun beams (UV).

The cover of the present invention comprises filtration means and it is designed to allow the passage of air therethrough while protecting the baby by filtering the air passing therethrough and keeping the baby stay-space cleaner and safer for the baby. Environment afflictions include, but not limited to, bacterias, viruses, dust pollutants, air pollution and insects.

The cover efficiently filters the environment afflictions while allowing the passage of oxygen (O2) into, and the passage of carbon dioxide (CO2)out of, the infant's facility it covers, thereby making the cover breathable.

In the preferred embodiment of the invention the outer layer of the cover entraps large contaminates such as dust, large dust pollutants and also traps at least a portion of the bacteria or other germs. The intermediate (middle) layer entraps contaminates that have passed through the first layer and is doing most of the filtering.

In the following description two specific preferred embodiments of the cover of the invention will be described in details:

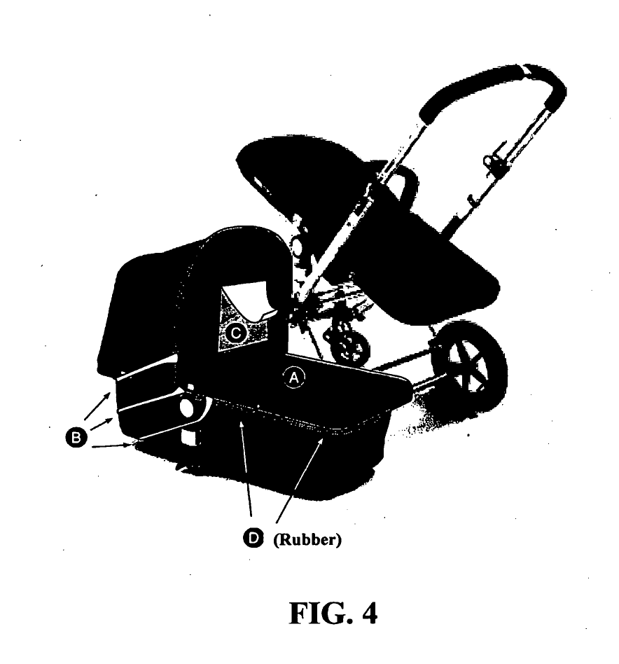

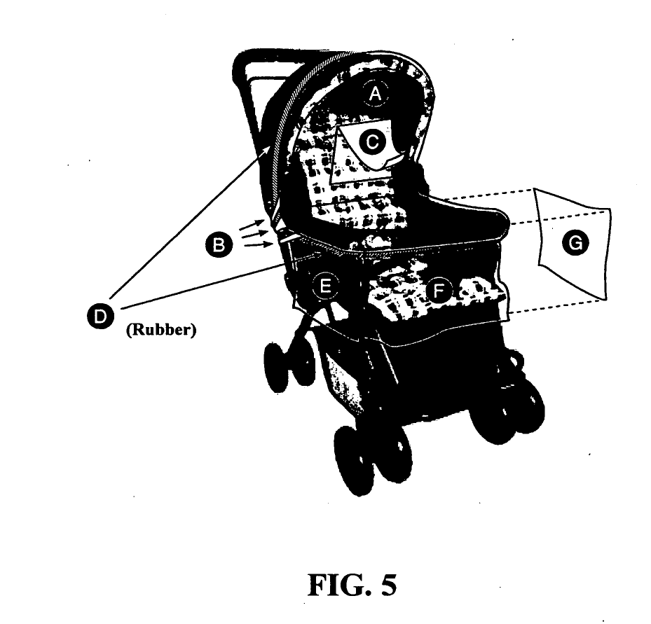

i) A cover for infant's facilities designed to protect several types of Baby strollers (FIGS. 4 and 5); and

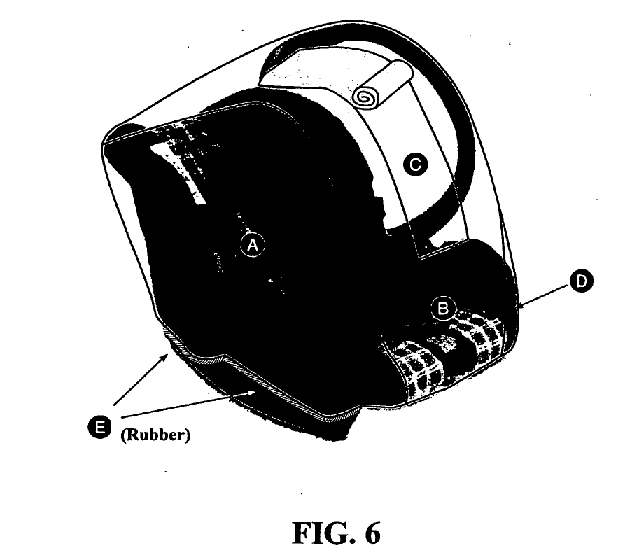

ii) A cover for infant's facilities designed to protect carrycots (FIG. 6).

These specific preferred embodiments of the invention are unique in their composite materials and in the way the cover is placed on the baby stroller and the baby carry-cot.

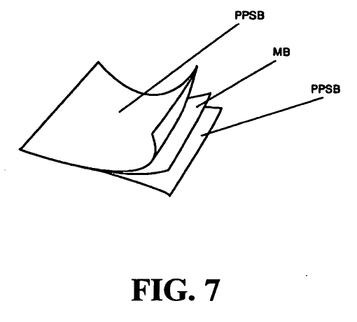

With reference to FIG. 7, the cover of the present invention is preferably composed of three layers of non woven fabric. The layers adapt said cover to filter the environment afflictions while allowing passage of O2 into the covered infant facility, and allowing passage of CO2 therefrom.

The outer layer of the cover is designed to entrap large contaminates such as dust, large dust pollutants and also traps at least a portion of the bacteria or other germs, and the middle layer, made of MB Meltblown, entraps contaminates that have passed through the first layer.

The cover of the present invention may comprise a single layer. The cover may comprise additional one or more layers made of composite non woven fabric or any other breathable fabric that can be attached to the non woven fabric, such as film fabric.

Of course, the different layers of the cover of the invention can be made of any other fabric having suitable properties, as described hereinabove.

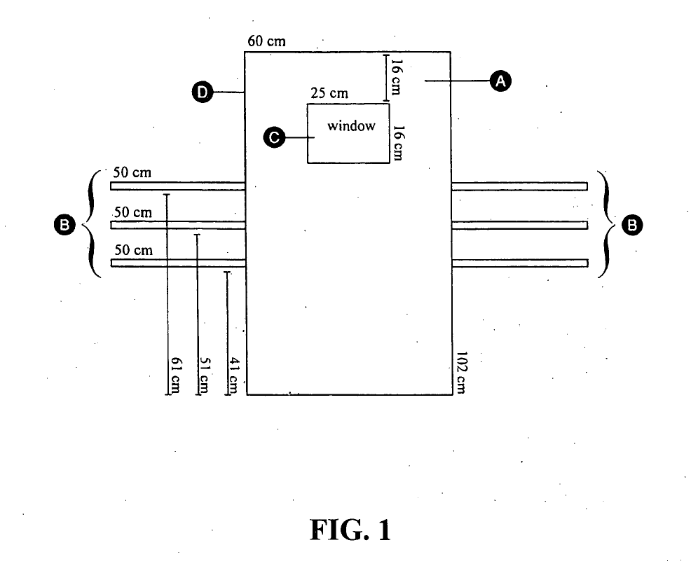

Additional accessories such as perfume can be spread on the inner fabric for the purpose of pleasant stay of the baby. The three layers are sewed together (or attached together by any other suitable technique) in a rectangle structure (see part A, in FIG. 1). In the mid-upper part of the rectangle a transparent plastic window is placed (part C, in FIG. 1).

This transparent window allows to view the baby inside the stroller. Optionally, the window may be covered by a respective piece of the non-woven material of the outer layer of the cover (part C in FIG. 4)

A rubber band is attached to the rectangle sides of the cover for the purpose of easy and quick gripping of the rectangular cover over the opening of the stroller (see part D, in FIG. 1).

Gripping the cover over the stroller, as shown in FIG. 4, provides full cover of the stroller opening. The longer sides of the rectangular cover include one or more fabric strips attached thereto (see part B, FIG. 1).

The strips are used for tying (or attaching by means of velcro or any other fastening means) the cover to the back of the stroller (see part B, FIG. 4).

The strips' tightening enable the cover to fully match its form to the stroller form and thereby to provide maximum impermeability.

The tightening and binding of the strips around the back of the stroller allows to partially uncover the opening by removing the upper or lower portions of the cover while leaving the other one close without taking the whole cover off.

As mentioned, more than one strip on each of the rectangle sides can be placed and be used for additional tightening around other points of the stroller (see part B, FIG. 1).

In order to adjust the cover structure to different types of baby strollers in which the above described rectangular cover cannot fully cover the front lower part of the stroller, additional 3 rectangles, each of which comprises similar three layers, can be attached as exemplified in FIG. 5 (see parts E,F and G, FIG. 5).

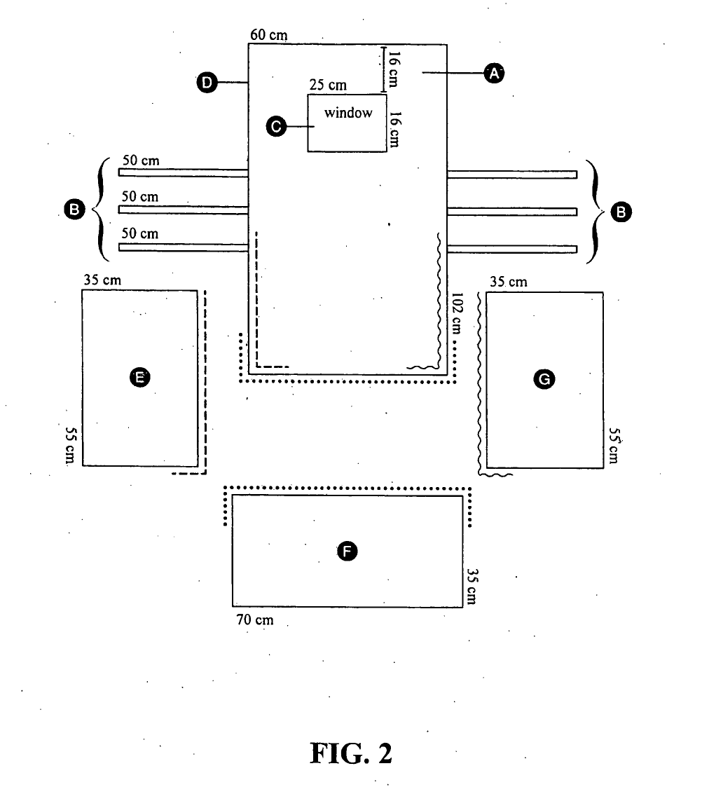

The three rectangles (E, F and G) are sewed (or attached by any other technique) to the main cover front to three sides of the main rectangles (see FIG. 2). These attachments enable the three covers to cover the front lower-part of the stroller and decrease the lower part exposure to bacterias; viruses dust pollutants and air pollutants.

The above described additional rectangles can be reversibly attached to the main rectangle by velcro. The additional three rectangles can be made of the same non-woven composites as the main rectangle, or from any other suitable fabric.

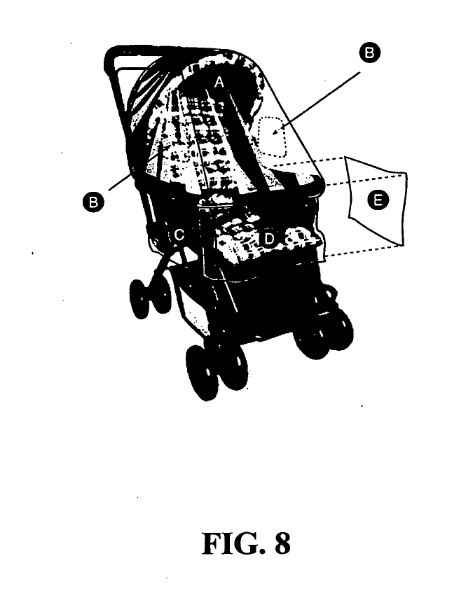

Another preferred embodiment of the invention for baby strollers is demonstrated in FIG. 8. In this embodiment the baby stroller cover focuses more on protection from rain and wind than protection from air pollutants. In this embodiment the cover is rain and wind protected and at the same time also breathable. The air that passes through the cover is filtered by the non-woven fabrics of the cover, as was described hereinabove.

As shown in FIG. 8, most of the cover is made from a transparent plastic material (see parts A, C, D and E, in FIG. 8), similar to the material from which the window shown in the first Baby Stroller Cover previously described hereinabove (see part C, FIG. 4). Along both sides of the cover sheets of material made of non woven fabric (see part B, in FIG. 8).

Of course, other materials having similar properties may be equally used. Alternatively, the filtering sheets may comprise only one layer having the required filtering characteristics. One or more additional layers may be added to said layer. The said additional layers are preferably made from a material allowing air passage therethrough, for example, a porous material.

The function of the plastic transparent material is to protect the baby from rain and wind while the function of part B in FIG. 8 is to filter the air passing therethrough. Part B can also be reversibly attached to the body of the main cover by velcro strips and thereby enables to replace this dispensable part after prolonged usage without the necessity to replace the whole cover.

The 1st described Baby stroller cover (shown in FIG. 4) of the invention may be prepared as follows: three layers of non-woven rectangles are sewed (glued or attached by any other form) together along their sides (the rectangle perimeter) (maybe in several sewing strips). A rubber strip is sewed (glued or attached by any suitable form) along side the three layers fabric sides and the edge of the fabric is folded and sewed therover (glued or any other form of attachment) (see part D, in FIG. 1). One or more tying strips may be attached to the long sides of the cover e.g, by sewing (see part B, in FIG. 1). A form, identical in shape to the transparent window is cut in three flanks while leaving the upper 4th flank attached of the main fabric for the purpose of covering the plastic window form the sun. A plastic window (or other transparent material) is placed and sewed (glued or attached by any other suitable means) in the mid-upper part of the fabric (see part C, FIG. 1). The window cover may be reversibly attached over the transparent material by means of velcro strips. The three possible additional rectangles may be prepared in the same way as the main fabric and then sewed (glued or attached) to the main rectangle structure as shown in FIG. 2.

With reference to FIG. 6, showing a preferred embodiment of the invention designed for baby Carry-cot, wherein the cover is preferably composed of the same three layers of non woven fabric (or any other fabric) previously described hereinabove.

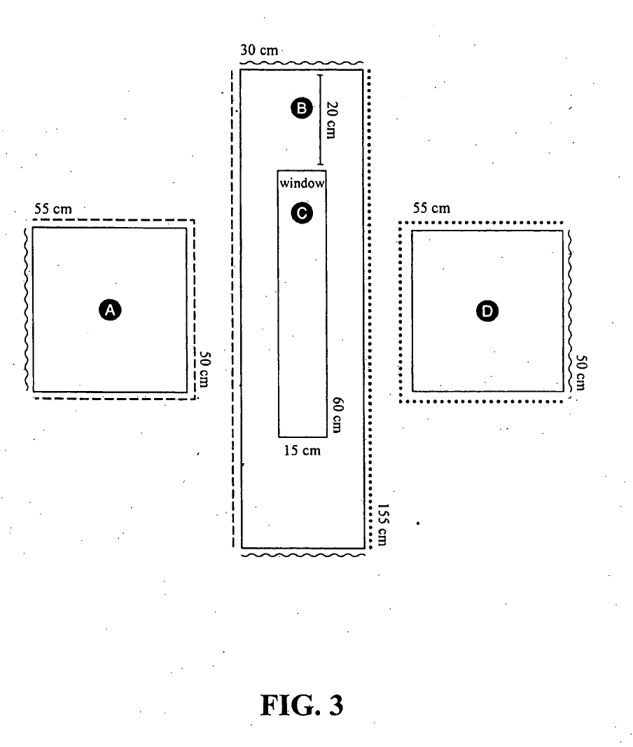

With reference to FIG. 3, the Carry-cot cover of the invention is composed of three parts each preferably having three non-woven fabric layers, wherein two square pieces (parts A and D) are joined together by a rectangle non-woven piece in the middle.

In the mid part of the rectangle or all along the length of the rectangle a transparent plastic window is placed. The transparent window enables to view the baby inside the Carrycot.

There is an option to cover the window by the non-woven cover. (see part C, FIG. 6)

A rubber band is attached to the rectangle open side flank and open flanks of the square pieces (see part E, FIG. 6) for the purpose of easy and quick gripping of the cover around the carry-cot.

The Carry-cot cover of the invention may be prepared as follows: three layers of the non-woven fabrics are sewed (glued or attachment by any other suitable means) along their sides to create three forms (maybe in several sewing strips).

The forms comprising the two square pieces and the rectangle described hereinabove. After the preparation of the two square pieces and the rectangle, said two square pieces and said rectangle are sewed (glued or attachment) as shown in FIG. 3 (see sewing instructions in FIG. 3.)

A form, identical to the transparent window is cut in three flanks while leaving the upper 4th flank attached of the rectangle fabric piece for the purpose of covering the plastic window form the sun. A plastic window (or any other transparent material) is placed and sewed (glued or attached) in the mid-upper part of the fabric (see part C, in FIG. 3).

Said transparent material may be reversibly attached by velcro. A rubber strip is sewed (glued or attached differently) along the sides of obtained structure (after sewing the three parts together) and the edges of said structure are folded and sewed (glued or attachment differently) over the rubber (See FIG. 3).

It should be noted that the baby stroller cover and the carry cot cover can be used on a dispensable basis and in a non-dispensable manner. Additionally, all of the parameters shown in the figs are given by way of example only, and may be changed in accordance with the differing requirements of the various embodiments of the present invention. Thus, the abovementioned parameters should not be construed as limiting the scope of the present invention in any way. In addition, it is to be appreciated that the different geometrical shapes may be equally used for the different members, described hereinabove. The above examples and descriptions have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A cover of a means for holding children and/or babies, the holding means having at least one opening, wherein the cover comprises:
(i) means for releasable fastening to the holding means, wherein attachment of the cover to the holding means enables the cover to match its form to openings of the holding means;
(ii) a layer configured to at least partially filter air introduced via the openings into the holding means, the layer comprising at least one layer comprising non-woven material;
(iii) at least one window, whereby the child in the holding means is capable of viewing outside the holding means, the windows comprising a layer impermeable to at least one of the group comprising: dust, air pollutants, viruses, bacteria, UV radiation, liquids and insects.

2. The cover of claim 1, further comprising at least one layer comprising film fabric material.

3. The cover of claim 1, comprising at least two layers, wherein the inner layer comprises film fabric material and the outer layer, facing openings of the holding means, comprises non-woven material.

4. The cover of claim 1, wherein areas of the cover facing openings of the holding means are at least partially permeable to oxygen and carbon dioxide and at least partially impermeable to at least one of the group comprising: dust, air pollutants, smog, viruses, bacteria, UV radiation, liquids and insects.

5. The cover of claim 1, wherein the cover is configured to at least partially block or reduce exposure of the child and/or baby from wind and/or light and/or noise and/or shock.

6. The cover of claim 1, further comprising attachment means comprising at least one of the group comprising drawstring, ribbon, Velcro, elastic band, cincture, hook, latch, lock, snare, snap, closure, clasp, snap fastener, pop fastener or press fastener, or clip.

7. The cover of claim 1, wherein the releasable fastening means is configured to match the form of the cover to openings of the holding means when the fastening means is tightened around the openings.

8. The cover of claim 7, wherein the tightening allows partial uncovering of the opening by removing or folding a portion of the cover.

9. The cover of claim 1, further comprising a light-impenetrable foldable layer for covering the window.

10. The cover of claim 1, configured to help retain heat within the holding means.

11. A means for holding children and/or babies, having at least one opening, configured to at least partially filter air introduced via the openings into the holding means and allow the baby and/or child viewing outside the holding means, by attachment of at least one cover comprising:
(i) means for releasable fastening to the holding means, wherein attachment of the cover to the holding means enables the cover to match its form to openings of the holding means;
(ii) a layer configured to at least partially filter air introduced via the openings into the holding means, the layer comprising at least one layer comprising non-woven material;
(iii) at least one window, whereby the child in the holding means is capable of viewing outside the holding means, the windows comprising a layer impermeable to at least one of the group comprising: dust, air pollutants, viruses, bacteria, UV radiation, liquids and insects.

12. The holding means of claim 11, wherein the covers enclose openings of the holding means.

13. The holding means of claim 11, wherein the holding means is configured with means for releasable fastening to attachment means on the filtering covers, wherein attachment of the covers to the holding means enables the covers to match their form to openings of the holding means.

14. The holding means of claim 11, the holding means selected from the group comprising: baby stroller, baby pram, baby carrier, baby carry-cots, baby incubator, baby bed, child bicycle seat or carriage, basinet, child motorcycle seat or carriage and rickshaw compartment.

15. The holding means of claim 11, further comprising a scaffold upon which at least one cover is laid, such as to create a comfortable gap between the child or baby and at least one cover.
